(19) United States
(12) Patent Application Publication
(10) Pub. No.: US 2015/0160014 A1
(43) Pub. Date: Jun. 11, 2015

(54) ROUTE MONITORING

(71) Applicant: International Business Machines Corporation, Armonk, NY (US)

(72) Inventors: James Hewitt, Eastleigh (GB); Ricky J. Moorhouse, Portsmouth (GB); Neil J. Ord, Fleet (GB); Caroline J. Thomas, Eastleigh (GB)

(21) Appl. No.: 14/546,338

(22) Filed: Nov. 18, 2014

(30) Foreign Application Priority Data
Dec. 10, 2013 (GB) 1321785.6

(51) Int. Cl. G01C 21/00

(52) U.S. Cl. CPC G01C 21/00

(57) ABSTRACT

A method of monitoring the location of a set of devices comprises the steps of providing route information to each device, detecting the location of each device, detecting that a first device has deviated from the predefined route information, and informing each other device in the set of devices that the first device has deviated from the predefined route information.

### CROSS-REFERENCE TO RELATED PATENT APPLICATION(S)

Pursuant to 35 U.S.C. §119, the present application claims priority to UK Patent Application No. 1321785.6, filed Dec. 10, 2013, the entire contents of which are incorporated herein by reference.

### FIELD OF THE INVENTION

This invention relates to a method of, and system for, monitoring the location of a set of devices.

### BACKGROUND

It is common for people to travel together when heading to the same destination. When travelling as a group, it is desirable to know when other parties following the same shared route have decided to make a stop, or take a different route. The reasons for this could be, for example, that one party has stopped to get food and/or petrol, and another party might want to stop at the same place for a shared meal, or that one party has broken down, and another party might want to go and help, and if one party has changed route, there might be a good reason, such as traffic problems or a closed road. Known solutions to this problem include planning stops; however, this typically requires upfront effort, is less flexible, and doesn't deal with unexpected stops, such as breakdowns. Another solution is that when making an unplanned stop or route change, one party can contact other parties in the group using a mobile phone; however, if there are large number of people travelling together, this can be time consuming and, if there are parties of one person in a vehicle, use of mobile phones may be illegal or not possible, for example, in groups of bikes and/or motorbikes.

### SUMMARY

According to a first aspect of the present invention, there is provided a method of monitoring the location of a set of devices, the method comprising the steps of providing route information to each device, detecting the location of each device, detecting that a first device has deviated from the predefined route information, and informing each other device in the set of devices that the first device has deviated from the predefined route information.

According to a second aspect of the present invention, there is provided a system for monitoring the location of a set of devices, the system comprising the set of devices arranged to provide route information to each device, detect the location of each device, detect that a first device has deviated from the predefined route information, and inform each other device in the set of devices that the first device has deviated from the predefined route information.

According to a third aspect of the present invention, there is provided a computer program product on a computer readable medium for monitoring the location of a set of devices, the product comprising instructions for providing route information to each device, detecting the location of each device, detecting that a first device has deviated from the predefined route information, and informing each other device in the set of devices that the first device has deviated from the predefined route information.

Owing to the invention, it is possible to provide a solution that will allow people who are undertaking the same journey to be automatically updated about the journey information of the other members of the party, should any member of the party deviate from the planned route. Each member of the party will have a device, such as a mobile phone, that can determine their location and can communicate with the other members of the party. Should any member of the party deviate from the planned route, then this will be detected by their mobile phone, and the other people who are making the same journey will be informed that one of their members has deviated from the route.

In a preferred embodiment, once it has been detected that a device has deviated from the planned route, the device will ascertain the reason for the deviation and this can be communicated to the other devices. In the context of a route, the deviation may comprise physically deviating from the planned route or may comprise taking an unscheduled stop that is longer than reasonable in normal traffic conditions.

In a preferred embodiment, at the start of a shared journey, the members of the party will synchronize their GPS devices to use the same route information, and to be in contact with each other. When a member of the group diverts from the route and the route needs to be re-planned, that information is shared with the other members of the group. Potentially, this could involve asking the driver if they want to do this first, in case they made a mistake and just need rerouting. When other members of the party receive the information about the deviation, then they are given the option to stay on route, or to follow the party that has diverted, thereby following a moving target.

### BRIEF DESCRIPTION OF THE DRAWINGS

Preferred embodiments of the present invention will now be described, by way of example only, with reference to the following drawings, in which:

FIG. 1 is a schematic diagram of a set of devices, in accordance with an embodiment of the present invention;

FIG. 2 is a schematic diagram of the set of devices at a later time, in accordance with an embodiment of the present invention;

FIG. 3 is a flowchart of a method of monitoring the location of the set of devices, in accordance with an embodiment of the present invention;

FIG. 4 is a schematic diagram of a mobile device, in accordance with an embodiment of the present invention; and

FIGS. 5 and 6 are schematic diagrams of a further example of a set of devices, in accordance with an embodiment of the present invention.

### DETAILED DESCRIPTION OF THE DRAWINGS

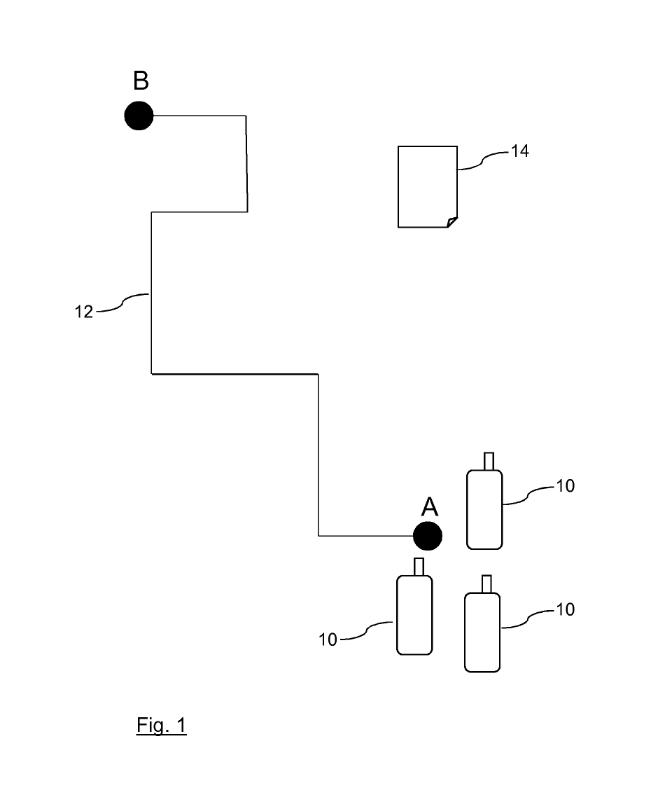

FIG. 1 shows a set of mobile devices 10, which are at a first location A and belong to users who wish to travel together to a different location B. The devices 10 could be suitable mobile phones that have location services enabled, for example by the use of GPS, which is common on modern smartphones. Each device 10 is the property of an individual who is making the journey from A to B, via the route 12. The devices 10 could belong to a number of different families who are going on holiday together and will each be using their own car to make the journey, but wish to travel together in convoy.

The route 12 from A to B is defined by route information 14, which can be in any suitable form that is understood by the mobile devices 10. In general, such GPS services work by the user specifying the target location B, while the device 10 knows the current location A from its internal GPS chip. The GPS service then calculates the route 12, which is embodied in the route information 14, and can be shared amongst all of the other devices 10 in the set of devices 10. Essentially suitable algorithms work out the most practical route from A to B using a stored map of the road and motorway network.

Each mobile device 10 is loaded with a specific application that is designed to monitor the locations of the device 10 as the journey is being undertaken and communicate with the other devices 10. The operation of this application will be described in more detail below. Modern smartphones support the delivery of applications from third parties via a suitable online store. For example, smartphones that use the Android operating system can easily be provided with third party software applications that are executed by the mobile phone's processor and can interact with the mobile phone's GPS capabilities and communicate externally using the mobile phone's wide area connectivity. The application can also access the route information 14.

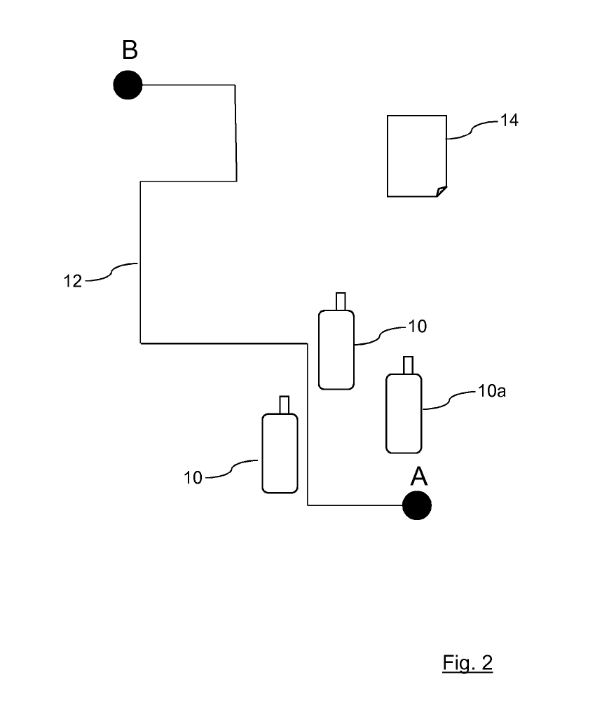

FIG. 2 shows the same mobile devices 10 as FIG. 1, but the journey being undertaken has now begun, as shown by the changed position of the devices 10. As the journey continues, traffic conditions and the nature of road junctions will mean that the different individuals undertaking the journey in their different vehicles will quickly lose visible connection. This will be particularly true on longer journeys and when there are a large number of parties undertaking the journey. Each party in the journey will have their own mobile device 10 with them, which will keep the different parties in touch via the operation of the specific application that has been loaded onto each of the mobile devices 10.

Each device 10, via the application, is arranged to detect the current location of the respective device 10. This detection can be undertaken continuously or, more likely, periodically, for example every five seconds. The application is also arranged to detect the deviation of the respective device 10 from the predefined route information 14. This deviation can take one of two different forms: firstly, that the mobile device 10 is stationery for longer than a predetermined length of time, or that the first device 10 has physically deviated from the route by a predetermined distance. The predetermined length of time might be one minute, for example, and the predetermined distance might be twenty meters, for example.

Once a mobile device 10 has detected that the respective device 10 has deviated from the predefined route information 14, then the device 10 will communicate with all of the other devices 10 in the set of devices 10, essentially informing each other device 10 in the set of devices 10 that the specific device 10 has deviated from the predefined route information. In FIG. 2, the device 10a has deviated from the route, and this will be detected by the specific device 10a, which will then communicate with the other devices 10. After the detection of deviation of a device 10a, there may be local communication first, prior to informing the other devices 10; this will be discussed in more detail below.

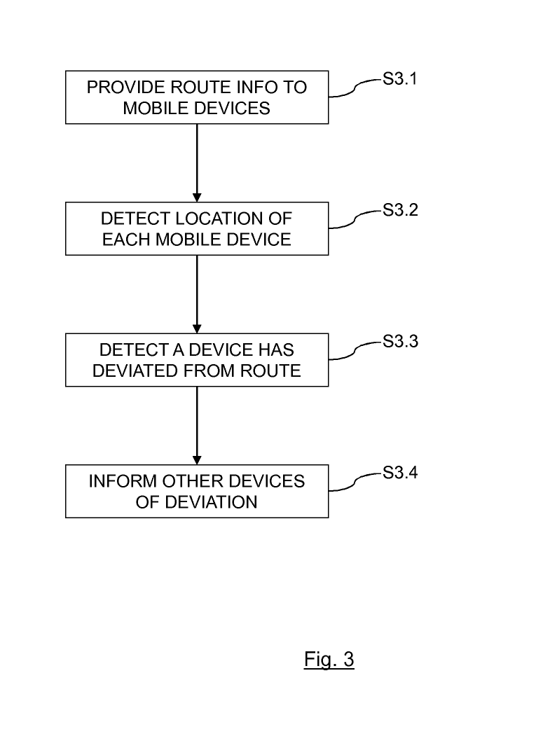

FIG. 3 shows a flowchart summarizing the basic method of monitoring the location of the set of devices 10. The method contains the steps of, firstly step S3.1, which comprises providing route information 14 to each device 10. The route information 14 may be in any form that is understood by the individual devices 10. The route information 14 could simply be the final destination of the individuals making the shared journey, if each device 10 will work out the same route from that destination, or the route information 14 could be the detail of the actual route in terms of the roads and motorways to be used when travelling to the destination.

The next step of the method is step S3.2, which comprises detecting the location of each device 10. As mentioned above, the detection process can occur continuously or periodically, and each device 10 in the set of the device 10 will be using their local location service (such as a GPS based system) to monitor their own position. The next step is step S3.3, which comprises detecting that a first device 10 has deviated from the predefined route information 14. This deviation, in terms of time or distance, indicates that the person with the device 10 has deviated from the planned route, and this is detected by the application on the specific device 10.

The final step of the method is step S3.4, which comprises informing each other device 10 in the set of devices 10 that a first device 10 has deviated from the predefined route information 14. Once it has been determined that a specific device 10 has deviated from the pre-planned route, the other devices 10 in the set of devices 10 are duly notified of this deviation. As mentioned above, there may be mediation by the specific device 10 before notification, for example, to determine the cause of the deviation and/or to give the respective user of the device 10 the chance to correct the detected deviation, if it was inadvertent.

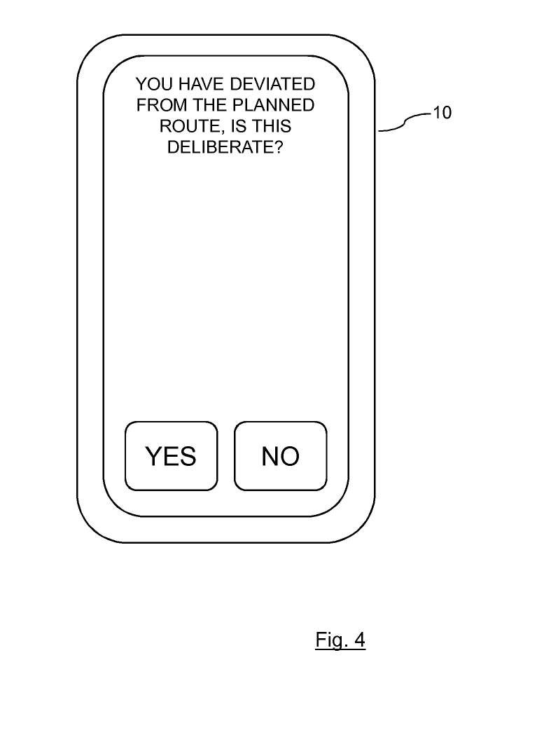

When it is detected that a device 10 has deviated from the route that the group of travelers are taking, there is not necessarily an immediate message sent to the other devices 10 in the set of devices 10. This can allow for the correction of mistakes and/or for the provision of feedback to the other devices 10. The application being run by the user's device 10 can first pose a question in relation to the detected deviation. For example, once deviation from the expected route has been detected, an audio output can be generated from the mobile device 10, for example stating, “You have deviated from the planned route, is this deliberate?”, as shown in FIG. 4.

All mobile devices 10 are provided with input functions, such as dedicated buttons and/or a touchscreen and, indeed, some modern smartphones also accept audio inputs and use speech recognition software. The user of the smartphone 10 could, therefore, provide a response, either answering “yes” or “no” to the question above. If the user answers “no” (for example, by pressing a suitable button on the mobile device 10), then the GPS route software could navigate the user back to the route, as it can be understood that the specific user took a wrong turn in their travels. In this case, no notification is made to the other devices 10, which are unaware of the detour.

If the user answers “yes” however, then the mobile device 10 may continue to interrogate the user of the device 10 to determine the reason for the deviation. For example, the traveler may be stopping for petrol or food, as is common on long journeys. Once the traveler has given a reason for their unscheduled stop, then a message can be sent to the other devices 10, advantageously with the reason provided included in the message. All of the other devices 10 will then receive and output a message such as “Dave has stopped for lunch at a service station”. The other travelers can then decide whether to stop as well.

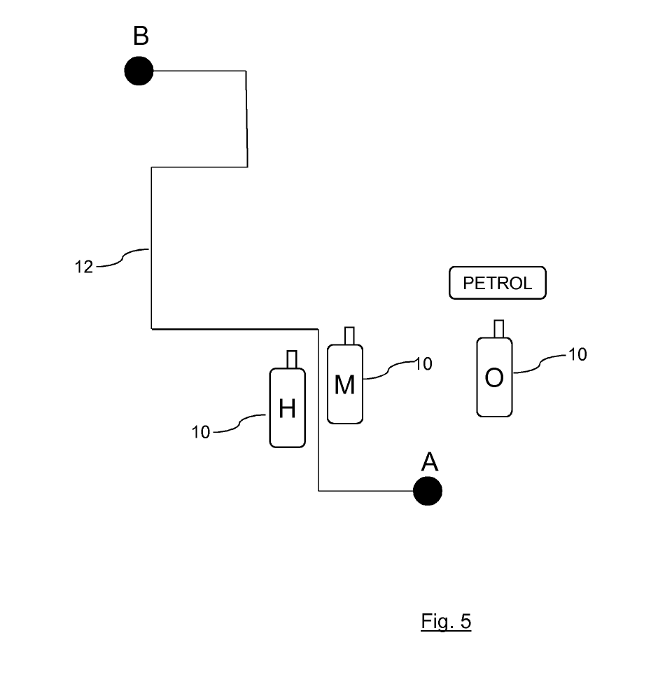

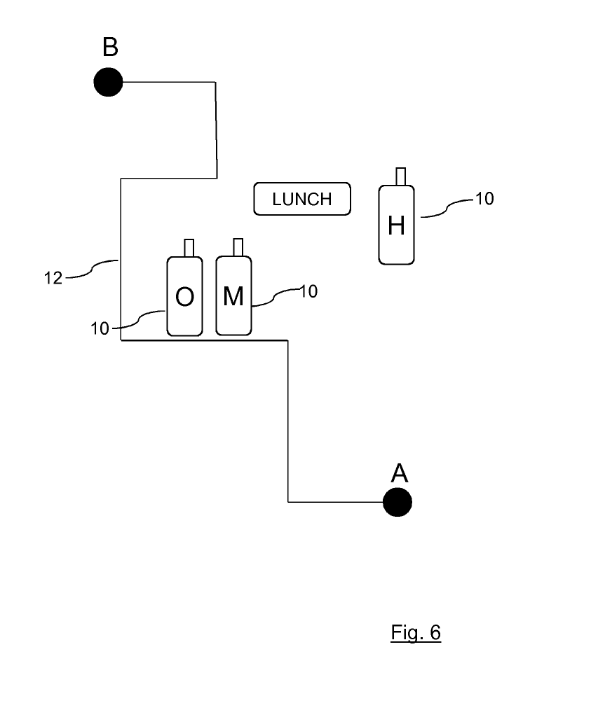

FIGS. 5 and 6 illustrate an example that covers three devices with different users. A group of friends are travelling to Cornwall from Eastleigh. They have a five hour drive to get to the property they have rented together. There are three couples, each going in their own car. The three couples are the Hewitts, the Ords and the Moorhouses. They have no lunch plans, because they do not know what will be available, but have decided they will stay in touch and stop for lunch when they see somewhere good at about the right time.

The group sync their route together, which can be carried out using existing technology, see Waze/iOS maps for example. The group sets off following the shared route, and their relative positions are shown on each other's screens. After thirty minutes, the Ords realize they need some petrol and divert from their route when they see a sign for a petrol station, as shown in FIG. 5. The application on their mobile device recognizes a deviation from route and using voice asks “You have diverted from your route. Did you mean to divert from your route?”. The Ords respond saying “Yes”. Now the GPS asks “Notify fellow travelers of your diversion?” (the other travelers will still see their location via the GPS, so this question is around whether the others should be alerted to this change in route because it might interest them). The Ords reply “No”, and the others are not alerted. They get their petrol, and the GPS application navigates them back onto the route.

At about 13:30, the Hewitts spot a really nice gastro-pub with a lovely garden and think this might be a great place for lunch so pull off the road towards the car park, see FIG. 6. The GPS application recognizes a deviation from route and using voice asks “You have diverted from your route. Did you mean to divert from your route?”. The Hewitts respond saying “Yes”. Now the GPS application asks “Notify fellow travelers of your diversion?” The Hewitts reply saying “Yes”. The application then asks “Why are you diverting from your route?”. The Hewitts reply by saying “Lunch”. Now the system sends a message to the synced devices 10.

The Ords and the Moorhouses receive a voice prompt saying, “The Hewitts have diverted for lunch. Would you like to follow them?”. The Ords say “Yes”, and the system reroutes them to the Hewitt's location. The Hewitts and the Moorhouses receive a voice prompt saying “The Ords are following the Hewitts”. The Moorhouses say “No”, as they have decided they no longer wish to stop for lunch, and the system leaves them on their current route. The Hewitts and the Ords receive a voice prompt saying “The Moorhouses are remaining on the original route”.

The Hewitts and the Ords enjoy their lunch, and then continue on their original route. At 15:07, the Moorhouses take a wrong turn at a roundabout in Devon. The GPS application recognizes a deviation from route and using voice asks “You have diverted from your route. Did you mean to divert from your route?”. The Moorhouses say “No”, and the GPS application reroutes to get them back on track. Despite their set-back, the Moorhouses arrive first. An hour later, and within minutes of each other, the Ords and Hewitts arrive. When the GPS application recognizes that all parties sharing the route have checked in at the final destination, the syncing is stopped and location information is no longer shared.

What is claimed is:

1. A method of monitoring the location of a set of devices, the method comprising the steps of:
providing, by a computer processor, predefined route information to each device of the set of devices;
detecting, by a computer processor, the location of each device of the set of devices;
detecting, by a computer processor, that a first device of the set of devices has deviated from the predefined route information; and
informing, by a computer processor, each other device of the set of devices that the first device has deviated from the predefined route information.

2. The method of claim 1, wherein the step of detecting, by a computer processor, that a first device of the set of devices has deviated from the predefined route information comprises detecting, by a computer processor, that the first device has remained stationery for a predetermined length of time.

3. The method of claim 1, wherein the step of detecting, by a computer processor, that a first device of the set of devices has deviated from the predefined route information comprises detecting, by a computer processor, that the first device has physically deviated from a predefined route by a predetermined distance.

4. The method of claim 1, further comprising: following detection, by a computer processor, that a first device of the set of devices has deviated from the predefined route information, outputting, by a computer processor, a warning signal from the first device.

5. The method of claim 1, further comprising: following detection, by a computer processor, that a first device of the set of devices has deviated from the predefined route information, receiving an input at the first device and transmitting a message derived from the received input to each other device of the set of devices.

6. A system for monitoring the location of a set of devices, the system comprising the set of devices, wherein each device of the set of devices is configured to:
receive predefined route information;
detect the location of each device of the set of devices;
detect that a first device of the set of devices has deviated from the predefined route information; and
inform each other device of the set of devices that the first device has deviated from the predefined route information.

7. The system of claim 6, wherein each device of the set of devices is configured to detect that a first device of the set of devices has remained stationery for a predetermined length of time.

8. The system of claim 6, wherein each device of the set of devices is configured to detect that a first device of the set of devices has physically deviated from the route by a predetermined distance.

9. The system of claim 6, wherein the first device is configured to, following detection that the first device has deviated from the predefined route information, output a warning signal.

10. The system of claim 6, wherein the first device is configured to, following detection that the first device has deviated from the predefined route information, receive an input at the first device and transmit a message derived from the received input to each other device of the set of devices.

11. A computer program product on a computer readable medium for monitoring the location of a set of devices, the computer program product comprising instructions for:
providing predefined route information to each device of the set of devices;
detecting the location of each device of the set of devices;
detecting that a first device of the set of devices has deviated from the predefined route information; and
informing each other device of the set of devices that the first device has deviated from the predefined route information.

12. The computer program product of claim 11, wherein the instructions for detecting that a first device of the set of devices has deviated from the predefined route information comprise instructions for detecting that the first device has remained stationery for a predetermined length of time.

13. The computer program product of claim 11, wherein the instructions for detecting that a first device of the set of devices has deviated from the predefined route information comprise instructions for detecting that the first device has physically deviated from the route by a predetermined distance.

14. The computer program product of claim 11, further comprising program instructions for, following detection that a first device of the set of devices has deviated from the predefined route information, outputting a warning signal from the first device.

15. The computer program product of claim 11, further comprising program instructions for, following detection that a first device of the set of devices has deviated from the predefined route information, receiving an input at the first device and transmitting a message derived from the received input to each other device of the set of devices.
